(19) United States
(12) Patent Application Publication
(10) Pub. No.: US 2015/0130812 A1
(43) Pub. Date: May 14, 2015

(54) Measured Data Digitization Apparatus, Measured Data Digitization Method and Non-Transitory Computer-Readable Medium

(71) Applicant: HITACHI HIGH-TECH SCIENCE CORPORATION, Tokyo (JP)

(72) Inventor: Shoichi Hasegawa, Tokyo (JP)

(73) Assignee: HITACHI HIGH-TECH SCIENCE CORPORATION, Tokyo (JP)

(21) Appl. No.: 14/538,323

(22) Filed: Nov. 11, 2014

(30) Foreign Application Priority Data
Nov. 11, 2013 (JP) 2013-233139

(51) Int. Cl. G06T 11/20

(52) U.S. Cl. CPC G06T 11/206
USPC 345/440

(57) ABSTRACT

A measured data digitization apparatus digitizes measured data based on image data obtained by reading paper data including the measured data indicated on an X-Y plane, and includes a straight line extracting unit extracting straight lines from the image data, an X-Y axis obtaining unit obtaining two orthogonal straight lines as X and Y axes, respectively, a numerical value obtaining unit obtaining numerical values around the X and Y axes from the image data, an area setting unit setting an area on the X-Y plane defined by the X and Y axes based on minimum and maximum values of the numerical values that are respectively obtained for the X and Y axes and a measured data obtaining unit obtaining the measured data in the area as numerical value data on the X and Y axes from the image data.

This application claims priority from Japanese Patent Application No. 2013-233139 filed on Nov. 11, 2013, the entire subject-matter of which is incorporated herein by reference.

### BACKGROUND

1. Technical Field

The disclosure relates to a measured data digitization apparatus that digitizes data indicated on a paper surface, a measured data digitization method and a non-transitory computer-readable medium.

2. Description of the Related Art

In the related art, there is a technique that reads character information printed on paper by an image reader by using optical character recognition (OCR) or the like and digitizes the read character information (see JP-A-11-272871).

In a measuring device such as a thermal analyzer, analysis is performed by plotting measured data as a graph on an X-Y plane of an X-axis and a Y-axis to read measured values on the graph or to calculate the area of a peak portion. The measured data is digitized and stored in a computer, and is analyzed on analysis software of the computer. Here, in many cases, while the electronic data is stored as backup data in the measuring device or the computer, the graph or the analysis result is printed on a paper surface for storage.

When it is desired that the previously measured data be analyzed, if the measuring device or the computer is already started, the analysis can be performed using the device or the computer. However, if the measuring device or the computer is not started, it is necessary to visually analyze the measured data on the paper surface.

### SUMMARY

When the measured data is visually analyzed on the paper surface, there is a high possibility that variation occurs for each user who performs the analysis even only when reading the data values on the graph.

Further, even though the measuring device or the computer is started, for example, when the previously measured data is analyzed by analysis software having a format different from that of current analysis software, the latest measured data and its analysis result may not be directly compared with the previously measured data and its analysis result. Particularly, since the analysis software has higher accuracy and more functions as it is newer, it is preferable that the analysis be performed by the latest analysis software.

Further, measured data stored only in a paper surface cannot be analyzed by the analysis software.

Therefore, illustrative aspects of the invention provide a measured data digitization apparatus and a measured data digitization program capable of easily digitizing measured data on an X-Y plane indicated on a paper surface as numerical value data.

According to one illustrative aspect of the invention, there may be provided a measured data digitization apparatus configured to read paper data indicated on a paper surface as image data by using an image reader, the paper data including measured data indicated on an X-Y plane formed of an X-axis and a Y-axis, and to digitize the measured data based on the image data, the measured data digitization apparatus comprising: a processor configured to operate as: a straight line extracting unit configured to extract two or more straight lines having a length of a predetermined ratio or greater with respect to an image size of the image data from the image data; an X-Y axis obtaining unit configured to obtain two straight lines that are orthogonal to each other from among the straight lines as the X-axis and the Y-axis, respectively; a numerical value obtaining unit configured to obtain numerical values disposed in the vicinity of the X-axis and the Y-axis from the image data; an area setting unit configured to set an area on the X-Y plane defined by the X-axis and the Y-axis, based on minimum values and maximum values of the numerical values that are respectively obtained for the X-axis and the Y-axis; and a measured data obtaining unit configured to obtain the measured data in the area as numerical value data on the X-axis and the Y-axis from the image data.

According to the measured data digitization apparatus, the X-axis and the Y-axis are obtained from the image data, the numerical values disposed in the vicinity of the X-axis and the Y-axis are further obtained to set the area on the X-Y plane, and the measured data in the area is obtained as the numerical value data on the X-axis and the Y-axis. Thus, the measured data indicated on the paper surface can be easily digitized as the numerical value data.

The X-Y axis obtaining unit may obtain two straight lines selected by a user from among the straight lines extracted by the straight line extracting unit as the X-axis and the Y-axis, respectively.

The numerical value obtaining unit may obtain the numerical values input by a user.

In this case, even though the numerical value obtaining unit mistakenly reads the numerical values, the misrecognition can be corrected by the input of the user.

The X-Y axis obtaining unit may obtain two Y-axes that are orthogonal to the X-axis, and when there are two types of measured data in the area, the measured data obtaining unit may obtain the two types of measured data as numerical value data on the X-axis and the corresponding Y-axes, based on correspondence information between the two types of measured data and the two Y-axes input by a user.

According to this measured data digitization apparatus, even though there are two types of measured data indicated on the paper surface, the measured data can be easily respectively digitized as individual numerical value data.

The processor may be configured to operate as: a character information obtaining unit configured to obtain character information disposed in the vicinity of the X-axis and the Y-axis from the image data, wherein the X-Y axis obtaining unit may set units of the X-axis and the Y-axis based on the character information, respectively.

The units of the numerical values on the X-axis and the Y-axis are not clear only by obtaining the minimum values and the maximum values of the numerical values. Thus, by obtaining the character information, the units of the numerical values on the X-axis and the Y-axis can be determined.

When numerical values on the X-axis and the Y-axis are respectively written in at least two points on the measured data, the area setting unit may set the area on the X-Y plane based on the numerical values, distances between the two points on the X-axis and the Y-axis, and distances between both ends of the measured data on the X-axis and the Y-axis.

When the respective numerical values are not given to the X-axis and the Y-axis, the numerical values are unable to be obtained by the numerical value obtaining unit, and the area setting are unable to be performed by the area setting unit. However, if the numerical values on the X-axis and the Y-axis (numerical values that represent the positions of the respective points on the X-axis and the Y-axis) are written in at least two points on the measured data, the area setting can be performed with reference to the numerical values.

There may be provided a method for digitizing measured data by reading paper data indicated on a paper surface as image data by using an image reader, the paper data including measured data indicated on an X-Y plane formed of an X-axis and a Y-axis, and by digitizing the measured data based on the image data, the method comprising: extracting two or more straight lines having a length of a predetermined ratio or greater with respect to an image size of the image data from the image data; obtaining two straight lines that are orthogonal to each other from among the straight lines as the X-axis and the Y-axis, respectively; obtaining numerical values disposed in the vicinity of the X-axis and the Y-axis from the image data; setting an area on the X-Y plane defined by the X-axis and the Y-axis, based on minimum values and maximum values of the numerical values that are respectively obtained for the X-axis and the Y-axis; and obtaining the measured data in the area as numerical value data on the X-axis and the Y-axis from the image data.

There may be provided a non-transitory computer-readable medium having a measured data digitization program stored thereon and readable by a computer, the measured data digitization program being for reading paper data indicated on a paper surface as image data by using an image reader, the paper data including measured data indicated on an X-Y plane formed of an X-axis and a Y-axis, and for digitizing the measured data based on the image data, the measured data digitization program, when executed by the computer, causes the computer to perform operations comprising: extracting two or more straight lines having a length of a predetermined ratio or greater with respect to an image size of the image data from the image data; obtaining two straight lines that are orthogonal to each other from among the straight lines as the X-axis and the Y-axis, respectively; obtaining numerical values disposed in the vicinity of the X-axis and the Y-axis from the image data; setting an area on the X-Y plane defined by the X-axis and the Y-axis, based on minimum values and maximum values of the numerical values that are respectively obtained for the X-axis and the Y-axis; and obtaining the measured data in the area as numerical value data on the X-axis and the Y-axis from the image data.

According to the illustrative aspects of the invention, the measured data on the X-Y plane indicated on the paper surface can be easily digitized as the numerical value data. For example, even in data based on different types of incompatible data analysis software, analysis can be performed by arbitrary common analysis software including the latest analysis software.

### BRIEF DESCRIPTION OF THE DRAWINGS

FIG. 1 is a block diagram illustrating an overall configuration of a measured data digitization apparatus according to an illustrative embodiment of the invention;

FIG. 2 is a diagram illustrating an example of a configuration of image data;

FIG. 3 is a diagram illustrating the flow of a digitization process of measured data;

FIG. 4 is a diagram illustrating an example of a configuration of image data having two Y-axes;

FIG. 5 is a diagram illustrating the flow of a digitization process of two or more types of measured data; and

FIG. 6 is a block diagram illustrating a configuration of a measured data digitization apparatus mounted on a camera-mounted terminal.

### DETAILED DESCRIPTION

Hereinafter, illustrative embodiments of the invention will be described with reference to the accompanying drawings.

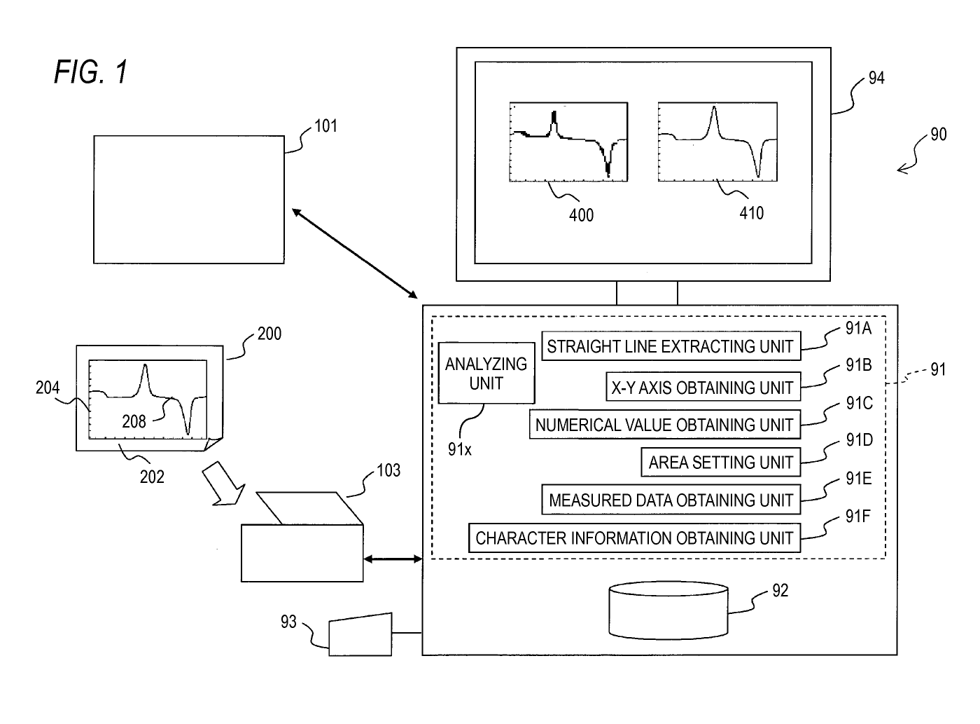

FIG. 1 is a block diagram illustrating an overall configuration of a measured data digitization apparatus 90 according to an illustrative embodiment of the invention. In FIG. 1, the measured data digitization apparatus 90 includes at least a control unit 91, wherein the control unit 91 includes a central processing unit (CPU) and a storage unit such as a ROM and a RAM that store data, programs, and the like. Further, in the illustrative embodiment, the measured data digitization apparatus 90 further includes a storage unit 92 configured by a hard disk or the like, an input unit 93 such as a keyboard that obtains an input instruction of a user, and a display unit 94 configured by a liquid crystal display or the like.

The measured data digitization apparatus 90 is configured by a microcomputer, a personal computer, or the like, for example. The measured data digitization apparatus 90 is coupled to a measuring device 101 such as a thermal analyzer, and to a known image reader 103 such as an optical character reader (OCR). In the present illustrative embodiment, an example in which a thermal analyzer is used as the measuring device 101 will be described. Further, as the image reader 103, not only a scanner but also a camera-mounted portable terminal such as a smart phone having an OCR function may be used.

The control unit 91 corresponds to a straight line extracting unit 91A, an X-Y axis obtaining unit 91B, a numerical value obtaining unit 91C, an area setting unit 91D, a measured data obtaining unit 91E and a character information obtaining unit 91F. The CPU of the control unit 91 is configured to execute various calculation processes based on a program stored in the storage unit 92 to control the respective components of the measured data digitization apparatus 90. The control unit 91 has a function of an analyzing unit 91x for analyzing digitized measured data. Incidentally, the control unit 91 may not include the analyzing unit 91x, and instead, the function of the analyzing unit 91x may be provided in the measuring device 101. The analyzing unit 91x executes predetermined analysis software to analyze measured data. For example, when the measuring device 101 is the thermal analyzer, the measured data is generally obtained by plotting differential scanning calorimetry (DSC) with respect to temperature, and calculation of the area of a peak of the DSC may be used as the analysis, for example.

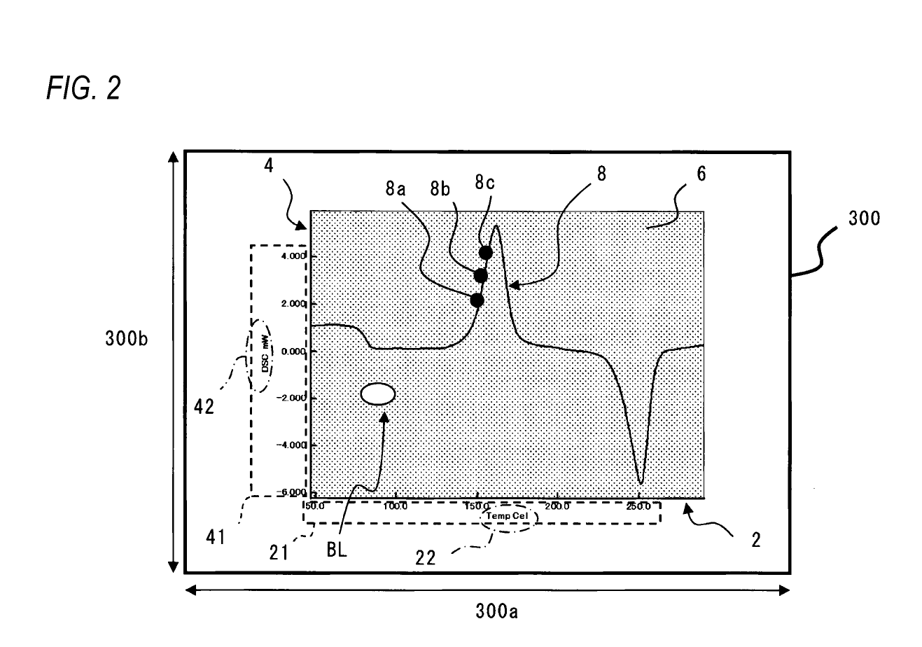

Next, a process performed by the measured data digitization apparatus 90 will be described with reference to FIGS. 1 and 2.

First, as shown in FIG. 1, paper data 200 indicated on a paper surface is read in advance as image data by the image reader 103. The paper data 200 includes an X-axis 202, a Y-axis 204, measured data 208 indicated (printed) on an X-Y plane, and numerical values and character information (not shown) which will be described later.

FIG. 2 is a diagram illustrating an example of a configuration of image data 300 read by the image reader 103. A lateral image size (the number of pixels) 300a and a longitudinal image size 300b of the image data 300 are determined. The image data 300 includes an X-axis 2 that represents temperature, a Y-axis 4 that represents DSC, measured data 8 plotted in an area 6 on the X-Y plane, numerical values 21 and 41, character information 22 and 42, and a stain BL. Further, the measured data digitization apparatus 90 digitizes the measured data 8 as numerical value data based on the image data 300.

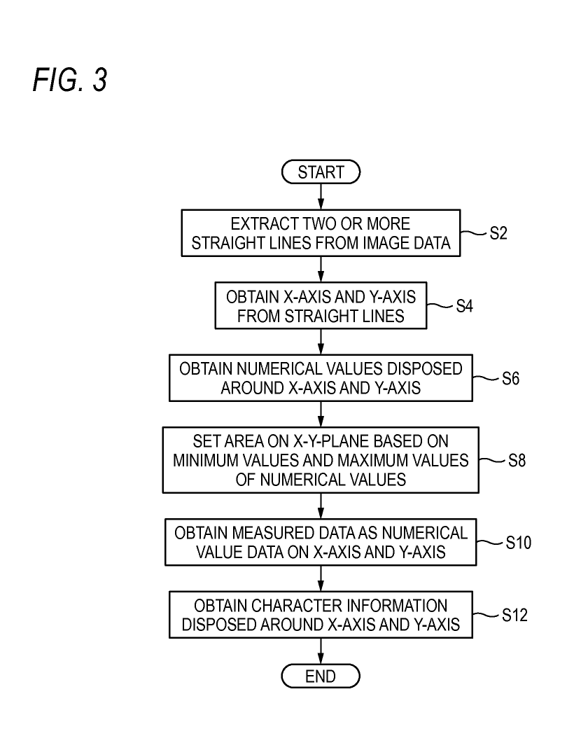

FIG. 3 is the flow of a process in which the measured data digitization apparatus 90 (control unit 91) digitizes the measured data 8.

First, in step S2, the straight line extracting unit 91A extracts two or more straight lines having a length of a predetermined ratio or greater with respect to the image sizes 300a and 300b of the image data from the image data 300. Since the X-axis and the Y-axis are relatively long straight lines in the image data 300, the straight lines including the X-axis and the Y-axis can be reliably extracted in step S2. Incidentally, since the X-axis and the Y-axis are normally respectively close in parallel to a transverse side and a longitudinal side of the image data 300, straight lines parallel to the transverse side and the longitudinal side of the image data 300 in a predetermined range may be extracted in step S2. Further, the predetermined ratio is 50% of the image sizes 300a and 300b, for example.

Then, in step S4, the X-Y axis obtaining unit 91B obtains two straight lines that are orthogonal to each other from among two or more straight lines extracted in step S2 as the X-axis 2 and the Y-axis 4, respectively. In step S4, it is assumed that the straight line that is close in parallel to the transverse direction of the image data 300 among the two straight lines that are orthogonal to each other is the X-axis. Incidentally, in step S4, the X-Y axis obtaining unit 91B may automatically obtain (select) the X-axis 2 and the Y-axis 4 from the straight lines extracted in step S2. Alternatively, the X-Y axis obtaining unit 91B may display two or more straight lines extracted in step S2 on the display unit 94, and a user may designate the X-axis 2 and the Y-axis 4. In this case, the user's designation is input to the input unit 93, and the X-Y axis obtaining unit 91B obtains the X-axis 2 and the Y-axis 4 based on the input information of the input unit 93.

Then, in step S6, the numerical value obtaining unit 91C obtains the numerical values 21 and 41 that are respectively disposed in the vicinity of the X-axis 2 and the Y-axis 4. Specifically, the numerical value obtaining unit 91C obtains the numerical value 21 disposed in a predetermined range from the X-axis 2, and similarly obtains the numerical value 41 disposed in a predetermined range from the Y-axis 4. Incidentally, the numerical value obtaining unit 91C may obtain the numerical values 21 and 41 as described above, but may obtain the numerical values 21 and 41 from user's input through the input unit 93 or the like. In the paper data 200, the numerical values can be clearly recognized and confirmed by visual recognition of the user, and thus, when the numerical values are mistakenly read in step S6, the misrecognition can be corrected by user's input. Specifically, for example, a process on the program for allowing the user to determine whether to authorize the numerical values on a confirmation screen after the numerical values are automatically read by the program in step S6 and prompting, when the numerical values are not authorized, the user to input the numerical values may be performed.

Next, in step S8, the area setting unit 91D sets the area 6 on the X-Y plane defined by the X-axis 2 and the Y-axis 4 based on minimum values and maximum values of the numerical values 21 and 41 that are respectively obtained on the X-axis 2 and the Y-axis 4. Specifically, a pixel coordinate on the image data 300 on the X-axis 2 is defined as a numerical value based on a minimum value “50” and a maximum value “250” among the numerical values 21 obtained with respect to the X-axis 2. Similarly, a coordinate on the Y-axis 4 is defined as a numerical value based on a minimum value “−6” and a maximum value “4” among the numerical values 41 obtained with respect to the Y-axis 4. In this way, the area 6 on the X-Y plane can be set. In the example of FIG. 2, the X-axis 2 extends up to a value larger than the maximum value “250”, but a numerical value up to a right end on the X-axis 2 is calculated based on the coordinate in “250” on the X-axis 2 and the coordinate of the right end on the X-axis 2. This is similarly applied to the Y-axis 4.

Incidentally, in a case where the numerical values 21 and 41 are not respectively attached to the X-axis 2 and the Y-axis 4, the obtaining of the numerical values using the numerical value obtaining unit 91C is unable to be performed, and the area setting using the area setting unit 91D is unable to be performed. However, so long as the numerical values on the X-axis and the Y-axis (numerical values that represent the positions of the respective points on the X-axis and the Y-axis) are written in at least two points on the measured data, the area setting can be performed with reference to the numerical values.

In this case, the area setting unit 91D reads the numerical values on the X-axis and the Y-axis that are respectively written in at least two points on the measured data. Then, the area setting unit 91D obtains distances between two points on the X-axis and the Y-axis, respectively. Further, the area setting unit 91D obtains distances between both ends of the measured data on the X-axis and the Y-axis, respectively. In addition, a projection portion on the X-axis in the area 6 on the X-Y plane is understood from the ratio between the distance between two points on the X-axis and the distance between the both ends of the measured data on the X-axis, and a difference of the numerical values on the X-axis that are respectively written on two points. Similarly, a projection portion on the Y-axis in the area 6 on the X-Y plane is understood from the ratio between the distance between two points on the Y-axis and the distance between the both ends of the measured data on the Y-axis, and a difference of the numerical values on the Y-axis that are respectively written on two points. In this way, the area 6 can be set.

Incidentally, selection of the acquisition of the numerical values 21 and 41 in the process of the normal step S6 by the area setting unit 91D or the reading of the numerical values of at least two points on the measured data may be performed by checking whether the numerical values are written in the vicinity of the points on the measured data when the numerical values 21 and 41 cannot be obtained in step S6, for example. Further, before and after step S6, a process on the program for prompting the user to perform an input of determining whether to perform the process of reading the numerical values of at least two points on the measured data may be performed.

Then, in step S10, the measured data obtaining unit 91E obtains the measured data 8 in the area 6 as the numerical value data on the X-axis 2 and the Y-axis 4. Specifically, the measured data obtaining unit 91E obtains measured data 8a, 8b, 8c, etc. at a predetermined interval on the X-axis 2 as coordinate (pixel) data, and converts the coordinate data of the measured data 8a, 8b and 8c into numerical value data corresponding to each of the numerical values on the X-axis 2 and the Y-axis 4, based on the correspondence between the coordinates and the numerical values calculated in step S8. For example, an image of which the lightness level to a background in the area 6 exceeds a predetermined threshold value is recognized as the measured data 8.

As described above, since the measured data 8 is digitized as the numerical value data, the measured data can be analyzed by the analyzing unit 91x.

Accordingly, the measured data indicated on the paper surface can be analyzed, and the measured data analyzed using analysis software having a different format can be analyzed again using desired analysis software. Thus, the latest measured data and its analysis result can be directly compared with different measured data and its analysis result.

In FIG. 1, an example in which an analysis result 400 of the digitized measured data 8 and an analysis result 410 of different measured data are displayed on the display unit 94 is shown.

Incidentally, in step S12, the character information obtaining unit 91F may obtain character information 22 and 42 that is respectively disposed in the vicinity of the X-axis 2 and the Y-axis 4. The units of the numerical values of the X-axis 2 and the Y-axis 4 are not clear only by obtaining the minimum values and the maximum values of the numerical values 21 and 41 in step S6. Thus, by obtaining the character information 22 and 42, the units of the numerical values of the X-axis 2 and the Y-axis 4 can be determined, and the measured data can be correctly analyzed. For example, in FIG. 2, “Temp Cel” is written in the vicinity of the X-axis 2 as the character information 22. Accordingly, it can be determined that the unit of the X-axis 2 is “temperature (° C.)”. Similarly, “DSC mW” is written in the vicinity of the Y-axis 4 as the character information 42. Accordingly, it can be determined that the unit of the Y-axis 4 is “mW” of DSC.

The X-Y axis obtaining unit 91B sets the units (temperatures (° C.) and DSC (mW)) of the X-axis 2 and the Y-axis 4 based on the above-described character information obtained by the character information obtaining unit 91F, respectively.

The process using the character information obtaining unit 91F may not be performed after step S10, and instead, may be performed at the same time as step S6, for example.

Incidentally, when the measuring device 101 is the thermal analyzer, for example, the measured data is generally plotted with the X-axis being temperature (° C.) and the Y-axis being differential calories (mW). Accordingly, by designating in advance the information indicating that the measured data relates to thermal analysis from the user or the measuring device 101 connected to the measured data digitization apparatus 90 (control unit 91), the measured data digitization apparatus 90 may regard that the unit of the X-axis is temperature (° C.) and the unit of the Y-axis is differential calories (mW), without performing the process using the character information obtaining unit 91F. In this case, the measured data digitization apparatus 90 may have a table of combinations of the units of the X-axis and the Y-axis according to the type of the measuring device 101.

Further, even when the units of the X-axis and the Y-axis are not clear, the digitized measured data can be used as a relative value without performing the process using the character information obtaining unit 91F.

Incidentally, if the stain BL is present in the area 6 on the X-Y plane of the image data 300 as shown in FIG. 2, there may be a concern that the stain BL is mistakenly recognized as the measured data 8. Thus, the measured data 8a, 8b and 8c that are respectively obtained as the measured data may be labeled, and for example, when a group of the same labels forms a closed curve, the group may be erased from the data by being regarded as the stain BL.

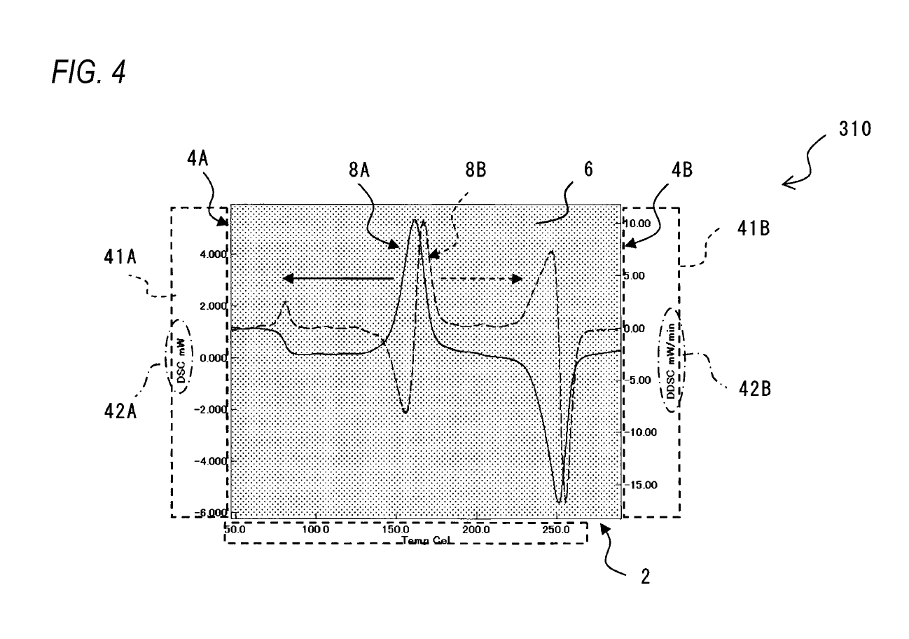

As shown in FIG. 4, the image data 310 may have two Y-axes 4A and 4B with respect to one X-axis 2. In the example of FIG. 4, the left Y-axis 4A has a unit of DSC (mW) (see character information 42A), and the right Y-axis 4B has a unit of DSC (mW/min) (see character information 42B). That is, the unit on the Y-axis 4B represents a temporal change of the unit on the Y-axis 4A.

Further, the measured data is formed by two types of data having different line types, in which measured data 8A indicated by a solid line corresponds to the Y-axis 4A, and measured data 8B indicated by a dashed line corresponds to the Y-axis 4B.

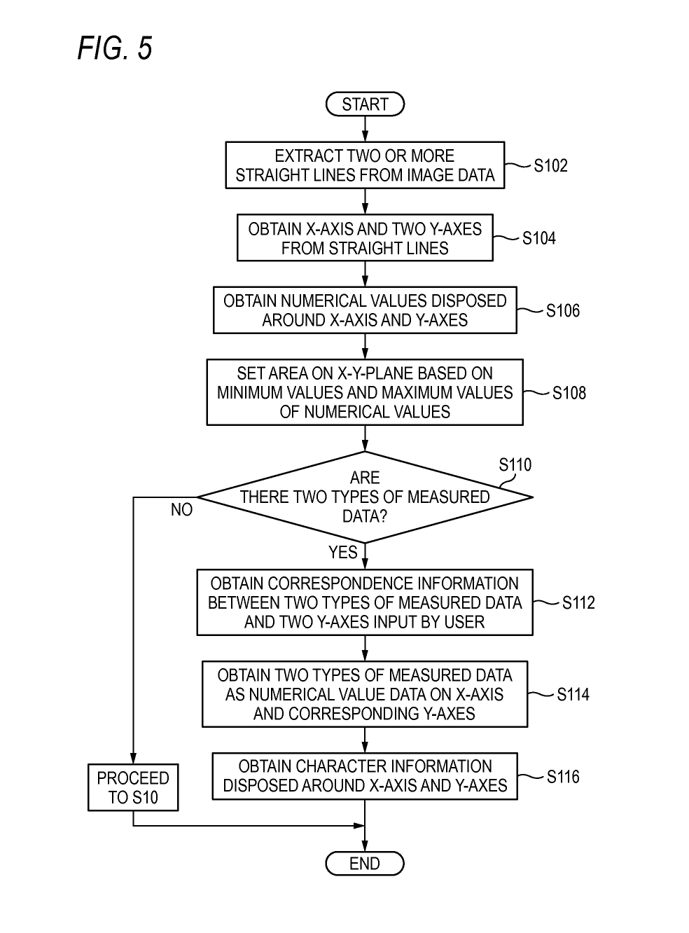

FIG. 5 shows the flow of a process in which two types of measured data 8A and 8B in FIG. 4 are digitized by the measured data digitization apparatus 90 (control unit 91).

First, in step S102, the straight line extracting unit 91A extracts plural straight lines from the image data 310. Since two Y-axes 4A and 4B are shown in FIG. 4, the straight line extracting unit 91A extracts three or more straight lines. The process of step S102 is the same as that of step S2.

Then, in step S104, the X-Y axis obtaining unit 91B obtains three straight lines that are orthogonal to each other from among three or more straight lines extracted in step S2 as the X-axis 2 and the Y-axes 4A and 4B, respectively. The process of step S104 is the same as that of step S4. Alternatively, the X-Y axis obtaining unit 91B may display three or more straight lines extracted in step S104 on the display unit 94, and the user may designate the X-axis 2 and the Y-axes 4A and 4B.

Then, in step S106, the numerical value obtaining unit 91C obtains numerical values 21, 41A and 41B that are respectively disposed in the vicinity of the X-axis 2 and the Y-axes 4A and 4B. The process of step S106 is the same as that of step S6.

Then, in step S108, the area setting unit 91D sets an area 6 on the X-Y plane defined by the X-axis 2 and the Y-axes 4A and 4B based on minimum values and maximum values of the numerical values 21, 41A and 41B that are respectively obtained on the X-axis 2 and the Y-axes 4A and 4B. The process of step S108 is the same as that of step S8.

Then, in step S110, the measured data obtaining unit 91E determines whether there are two types of the measured data 8A and 8B in the area 6. Here, the measured data obtaining unit 91E extracts, for example, color tones or characteristics of lines of the measured data 8A and 8B in the image data 310, and determines whether two types of measured data are present from the colors or line types of the measured data 8A and 8B.

If the determination result is “No” in step S110, since one type of measured data is present, the flow becomes the same as the flow in FIG. 3, and thus, the procedure proceeds to step S10 in FIG. 3.

On the other hand, if the determination result is “Yes” in step S110, the measured data obtaining unit 91E displays information indicating that there are two types of measured data 8A and 8B and two types of Y-axes 4A and 4B on the display unit 94. The user inputs correspondence information between the measured data 8A and 8B and the Y-axes 4A and 4B through the input unit 93, and the measured data obtaining unit 91E obtains the correspondence information (step S112).

Incidentally, instead of determining whether there are two types of measured data in step S110, the user may input in advance information indicating that there are two types of measured data, and the measured data obtaining unit 91E may determine that there are two types of measured data according to the input information.

Then, in step S114, the measured data obtaining unit 91E obtains two types of measured data 8A and 8B in the area 6 as numerical value data on the X-axis 2 and the corresponding Y-axes 4A and 4B, respectively. Specifically, the measured data obtaining unit 91E obtains the measured data 8A as numerical value data on the X-axis 2 and the Y-axis 4A, and obtains the measured data 8B as numerical value data on the X-axis 2 and the Y-axis 4B. The process of step S114 is the same as that of step S10.

Further, the character information obtaining unit 91F may obtain character information 22, 42A and 42B that are respectively disposed in the vicinity of the X-axis 2 and the Y-axes 4A and 4B in step S116, as necessary. The process of step S116 is the same as that of step S12.

As described above, even though there are two types of measured data 8A and 8B, since the measured data is digitized as the numerical value data, two types of measured data can be respectively analyzed by the analyzing unit 91x.

The invention is not limited to the above illustrative embodiments, and includes various modification and equivalents in a range without departing from the spirit and scope of the invention.

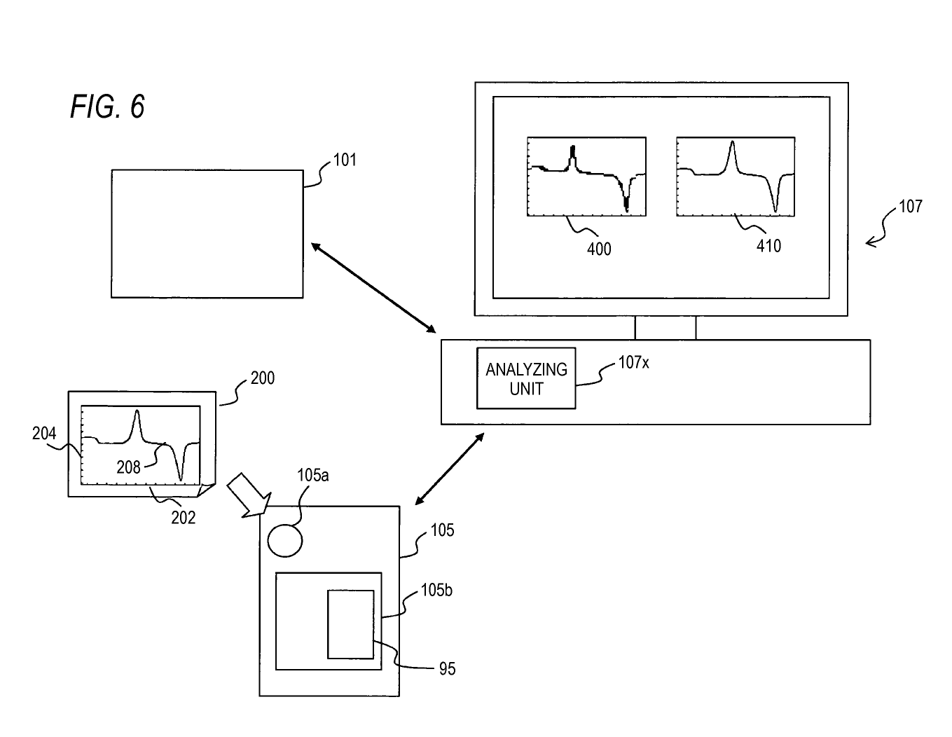

For example, as shown in FIG. 6, the measured data digitization apparatus 95 may be mounted on a camera-mounted terminal 105 such as a tablet terminal. The camera-mounted terminal 105 includes a camera 105a and a control unit 105b, in which the control unit 105b includes a central processing unit (CPU), a ROM, a RAM, and the like. Further, the measured data digitization apparatus 95 is realized as the control unit 105b. Specifically, the control unit 105b executes a computer program for realizing the measured data digitization apparatus 95. In addition, the control unit 105b executes a computer program for realizing an OCR function to read the paper data 200 as image data through the camera 105a. That is, the camera-mounted terminal 105 functions as the image reader 103.

Further, the control unit 105b digitizes measured data by the same process flow as in FIGS. 3 and 5, based on the image data generated by reading the paper data 200, and transmits the digitized measured data to a personal computer 107.

The personal computer 107 is mounted with analyzing unit 107x for analyzing the digitized measured data. The analyzing unit 107x analyzes the measured data by executing predetermined analysis software, similar to the analyzing unit 91x.

What is claimed is:

1. A measured data digitization apparatus configured to read paper data indicated on a paper surface as image data by using an image reader, the paper data including measured data indicated on an X-Y plane formed of an X-axis and a Y-axis, and to digitize the measured data based on the image data, the measured data digitization apparatus comprising:
a processor configured to operate as:
a straight line extracting unit configured to extract two or more straight lines having a length of a predetermined ratio or greater with respect to an image size of the image data from the image data;
an X-Y axis obtaining unit configured to obtain two straight lines that are orthogonal to each other from among the straight lines as the X-axis and the Y-axis, respectively;
a numerical value obtaining unit configured to obtain numerical values disposed in the vicinity of the X-axis and the Y-axis from the image data;
an area setting unit configured to set an area on the X-Y plane defined by the X-axis and the Y-axis, based on minimum values and maximum values of the numerical values that are respectively obtained for the X-axis and the Y-axis; and
a measured data obtaining unit configured to obtain the measured data in the area as numerical value data on the X-axis and the Y-axis from the image data.

2. The measured data digitization apparatus according to claim 1,
wherein the X-Y axis obtaining unit obtains two straight lines selected by a user from among the straight lines extracted by the straight line extracting unit as the X-axis and the Y-axis, respectively.

3. The measured data digitization apparatus according to claim 1,
wherein the numerical value obtaining unit obtains the numerical values input by a user.

4. The measured data digitization apparatus according to claim 1,
wherein the X-Y axis obtaining unit obtains two Y-axes that are orthogonal to the X-axis, and when there are two types of measured data in the area, the measured data obtaining unit obtains the two types of measured data as numerical value data on the X-axis and the corresponding Y-axes, based on correspondence information between the two types of measured data and the two Y-axes input by a user.

5. The measured data digitization apparatus according to claim 1, wherein the processor is configured to operate as:
a character information obtaining unit configured to obtain character information disposed in the vicinity of the X-axis and the Y-axis from the image data,
wherein the X-Y axis obtaining unit sets units of the X-axis and the Y-axis based on the character information, respectively.

6. The measured data digitization apparatus according to claim 1,
wherein when numerical values on the X-axis and the Y-axis are respectively written in at least two points on the measured data, the area setting unit sets the area on the X-Y plane based on the numerical values, distances between the two points on the X-axis and the Y-axis, and distances between both ends of the measured data on the X-axis and the Y-axis.

7. A method for digitizing measured data by reading paper data indicated on a paper surface as image data using an image reader, the paper data including measured data indicated on an X-Y plane formed of an X-axis and a Y-axis, and by digitizing the measured data based on the image data, the method comprising:
extracting two or more straight lines having a length of a predetermined ratio or greater with respect to an image size of the image data from the image data;
obtaining two straight lines that are orthogonal to each other from among the straight lines as the X-axis and the Y-axis, respectively;
obtaining numerical values disposed in the vicinity of the X-axis and the Y-axis from the image data;
setting an area on the X-Y plane defined by the X-axis and the Y-axis, based on minimum values and maximum values of the numerical values that are respectively obtained for the X-axis and the Y-axis; and
obtaining the measured data in the area as numerical value data on the X-axis and the Y-axis from the image data.

8. A non-transitory computer-readable medium having a measured data digitization program stored thereon and readable by a computer, the measured data digitization program being for reading paper data indicated on a paper surface as image data by using an image reader, the paper data including measured data indicated on an X-Y plane formed of an X-axis and a Y-axis, and for digitizing the measured data based on the image data, the measured data digitization program, when executed by the computer, causes the computer to perform operations comprising:
extracting two or more straight lines having a length of a predetermined ratio or greater with respect to an image size of the image data from the image data;
obtaining two straight lines that are orthogonal to each other from among the straight lines as the X-axis and the Y-axis, respectively;
obtaining numerical values disposed in the vicinity of the X-axis and the Y-axis from the image data;
setting an area on the X-Y plane defined by the X-axis and the Y-axis, based on minimum values and maximum values of the numerical values that are respectively obtained for the X-axis and the Y-axis; and
obtaining the measured data in the area as numerical value data on the X-axis and the Y-axis from the image data.
